(19) United States
(12) Patent Application Publication
(10) Pub. No.: US 2011/0299298 A1
(43) Pub. Date: Dec. 8, 2011

(54) BACKLIGHT MODULE

(75) Inventor: Chung-Cheng Liang, Taoyuan (TW)

(73) Assignee: GLOBAL LIGHTING TECHNOLOGIES INC., Taoyuan (TW)

(21) Appl. No.: 13/155,409

(22) Filed: Jun. 8, 2011

(30) Foreign Application Priority Data
Jun. 8, 2010 (TW) 99118547
Jun. 22, 2010 (TW) 99120276
Jul. 22, 2010 (TW) 99124179

(51) Int. Cl. F21V 7/22

(52) U.S. Cl. 362/607; 362/613; 362/606

(57) ABSTRACT

A backlight module including a plurality of light guide plates, a plurality of light emitting devices, and a back frame is provided. The adjacent light guide plates are coupled with each other to form a piece-coupled light guide plate. The light emitting devices provides light to the piece-coupled light guide plate. The back frame has a back sheet and a bending element. The back sheet has at least one broken hole. The bending element is disposed near the broken hole and forms an angle with the back sheet. The bending element has a locking groove, and the piece-coupled light guide plate is leaned against the locking groove. A supporting and fastening device can be adopted to further fasten the piece-coupled light guide plate and films below the piece-coupled light guide plate. Additionally, a reflector is disposed below the piece-coupled light guide plate for reflecting the light upwards.

### CROSS-REFERENCE TO RELATED APPLICATION

This application claims the priority benefits of Taiwan application serial no. 99118547, filed Jun. 8, 2010, Taiwan application serial no. 99120276, filed Jun. 22, 2010 and Taiwan application serial no. 99124179, filed Jul. 22, 2010. The entirety of each of the above-mentioned patent applications is hereby incorporated by reference herein and made a part of this specification.

### BACKGROUND OF THE INVENTION

1. Technical Field

The invention generally relates to a backlight module, and more particularly, to a backlight module with a piece-coupled light guide plate.

2. Description of Related Art

In recent years, liquid crystal display (LCD) device has been broadly applied to different electronic products (for example, notebook computers, digital cameras, and TVs) due to its many advantages such as light weight, slim appearance, small volume, and low power consumption.

A LCD device is usually composed of a LCD panel and a backlight module. The LCD panel adjusts the amounts of light passing through different pixel regions through the rotation of liquid crystal molecules and a polarizer, so as to produce light and shade variations within these pixel regions and hence display an image.

Because liquid crystal itself does not emit light, a backlight module is needed for providing a planar light source. Backlight modules can be categorized into side type backlight modules and direct type backlight modules. Due to the requirement of long light mixing distances to achieve a uniform mixed light, direct type backlight modules are usually thick therefore are not suitable for thin type display devices. Side type backlight modules can be adopted with light emitting diodes (LEDs) therefore are thinner.

Another type of backlight module is provided along with the increase in the sizes and contrast ratios of LCD devices. In such a backlight module, several small-sized light guide plates are coupled together to achieve a large-sized piece-coupled light guide plate. Besides, a display effect with a high dynamic contrast ratio can be achieved in a LCD device by incorporating a local dimming mechanism.

However, because the small-sized light guide plates have different luminosities, bright lines may be produced at where the small-sized light guide plates are coupled to each other, and accordingly the display quality of the LCD device is affected.

Additionally, the evenness of a piece-coupled light guide plate determines whether the planar light source provided by a backlight module is uniform. In other words, if a piece-coupled light guide plate and the films below the piece-coupled light guide plate are not properly fixed, the piece-coupled light guide plate and the films may warp and accordingly cannot provide a uniform planar light source.

Moreover, in a side type backlight module, there is not a sufficient light mixing distance between the light guide plate and the optical film above the light guide plate, so that the uniformity of the planar light source provided by the side type backlight module is also affected.

### SUMMARY

Accordingly, the invention is directed to a backlight module, wherein a piece-coupled light guide plate is maintained in an even state and a uniform planar light source is provided.

The invention provides a backlight module including a plurality of light guide plates, a plurality of light emitting devices, and a back frame. Adjacent light guide plates are coupled with each other to form a piece-coupled light guide plate. The light emitting devices provide a light to the piece-coupled light guide plate. The back frame has a back sheet and a bending element. The back sheet has at least one broken hole. The bending element is disposed near the broken hole and forms an angle with the back sheet. The bending element has a locking groove. The piece-coupled light guide plate is leaned against the locking groove.

According to an embodiment of the invention, each of the light guide plates has a light incidence portion and an opposite coupling portion, the light incidence portion and the adjacent coupling portion are coupled with each other to form the piece-coupled light guide plate, and a containing space is formed at the junction of the light incidence portion and the coupling portion.

According to an embodiment of the invention, the light emitting devices are disposed in the containing space and located at a side of the light incidence portion.

According to an embodiment of the invention, there is at least a protrusion at a side of the coupling portion of each of the light guide plates, and the protrusion is leaned against the locking groove.

According to an embodiment of the invention, the backlight module further includes a light diffuser, and the light diffuser is disposed on a surface of the coupling portion of each of the light guide plates which faces the light emitting devices.

According to an embodiment of the invention, the coupling sides of the adjacent light guide plates contact each other to form the piece-coupled light guide plate, and the light emitting devices are disposed at least one side of the piece-coupled light guide plate.

According to an embodiment of the invention, the backlight module further includes a cushion element, and the cushion element is disposed on the bending element.

According to an embodiment of the invention, the backlight module further includes a reflector, and the reflector is disposed below the piece-coupled light guide plate.

According to an embodiment of the invention, the reflector has a hole corresponding to the light emitting devices, and the light emitting devices can pass through the hole.

According to an embodiment of the invention, the backlight module further includes a circuit board disposed below the reflector, the light emitting devices are electrically connected to the circuit board, and the reflector is located between the circuit board and the piece-coupled light guide plate.

According to an embodiment of the invention, each of the light guide plates has a plurality of trenches, and the trenches divide the light guide plate into a plurality of light emitting areas.

According to an embodiment of the invention, a microstructure is disposed at a side of the light incidence portion of each of the light guide plates.

According to an embodiment of the invention, the backlight module further includes a supporting and fastening device. The supporting and fastening device has a body, a fastening portion, and at least one pressing portion. The fastening portion is connected to one end of the body, and the pressing portion is connected to one side of the body. The piece-coupled light guide plate has at least one through hole. The position of the through hole is corresponding to the position of the broken hole, and the piece-coupled light guide plate and the light emitting devices are disposed within the back frame. The fastening portion and a part of the body pass through the through hole of the piece-coupled light guide plate and the broken hole of the back frame. The fastening portion is fastened to the back frame. The pressing portion presses the light guide plates.

According to an embodiment of the invention, there are two pressing portions, and the two pressing portions are connected to both sides of the body.

According to an embodiment of the invention, the two pressing portions press against the piece-coupled light guide plate.

According to an embodiment of the invention, a recess is formed at least one corner of each of the light guide plates, and the recesses of the light guide plates form the through hole.

According to an embodiment of the invention, the backlight module further includes an optical plate assembly, and the optical plate assembly is leaned against the body.

According to the invention, the piece-coupled light guide plate can be directly leaned against the locking groove of the bending element by using the bending element of the back frame, so that the piece-coupled light guide plate can be properly fastened. Accordingly, the backlight module can provide a uniform planar light source.

In addition, according to the invention, a supporting and fastening device can be adopted to further fasten the piece-coupled light guide plate and the films below the piece-coupled light guide plate, and the supporting and fastening device offers a suitable light mixing distance between the piece-coupled light guide plate and the optical films above the piece-coupled light guide plate. Accordingly, a uniform planar light source can be provided.

In the invention, a plurality of light guide plates is coupled together to form a piece-coupled light guide plate, and a reflector is disposed below the piece-coupled light guide plate, so that a light can be reflected upwards by the reflector and accordingly the problem of bright lines in the conventional technique can be resolved and the light use efficiency can be improved. A light diffuser can be further disposed on the surface of the coupling portion of each light guide plate that faces the light emitting devices to further improve the uniformity of the light directly emitted upwards by the light emitting devices, so as to provide a more uniform planar light source.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a perspective view of a backlight module according to a first embodiment of the invention.

FIG. 2 is an enlarged view of area A in FIG. 1.

FIG. 3 is an enlarged view of area B in FIG. 1.

FIG. 4 is a perspective view of a light guide plate according to the first embodiment of the invention.

FIG. 5 is an enlarged view of area A in FIG. 4.

FIG. 6 is an enlarged view of area B in FIG. 4.

FIG. 7 is an enlarged view of area C in FIG. 4.

FIG. 8 is a perspective view of a backlight module according to the first embodiment of the invention.

FIG. 8A is a diagram of a cushion element according to the first embodiment of the invention.

FIG. 8B is a diagram of another bending element according to the first embodiment of the invention.

FIG. 9 is a cross-sectional view of a backlight module according to the first embodiment of the invention.

FIG. 10 is a perspective view of another backlight module according to the first embodiment of the invention.

FIG. 11 is a diagram of a light guide plate according to the first embodiment of the invention.

FIG. 12 is a diagram of another light guide plate according to the first embodiment of the invention.

FIG. 13 is a diagram of a plurality of light guide plates in FIG. 11 coupled together along a direction X.

FIG. 14 is a luminosity graph corresponding to a piece-coupled light guide plate in FIG. 13.

FIG. 15 is a diagram of another flat joint piece-coupled light guide plate, wherein a plurality of light guide plates is coupled together along a direction Y according to the first embodiment of the invention.

FIG. 16 is a luminosity graph corresponding to the piece-coupled light guide plate in FIG. 15.

FIG. 17 is a diagram of a liquid crystal display (LCD) device according to the first embodiment of the invention.

FIG. 18A is a perspective view of some components of a backlight module according to a second embodiment of the invention.

FIG. 18B is a perspective view of some components of another backlight module according to the second embodiment of the invention.

FIG. 19 is a cross-sectional view of the backlight module in FIG. 18B.

FIG. 20 is a diagram of another backlight module according to the second embodiment of the invention.

FIG. 21 is a perspective view of a light guide plate according to the second embodiment of the invention.

FIG. 22 is an enlarged view of area A in FIG. 21.

FIG. 23 is an enlarged view of area B in FIG. 21.

FIG. 24 is an enlarged view of area C in FIG. 21.

FIG. 25 is a perspective view of a piece-coupled light guide plate in FIG. 20.

FIG. 26 is a perspective view of a backlight module according to the second embodiment of the invention.

FIG. 27 is a cross-sectional view of a backlight module according to the second embodiment of the invention.

FIG. 28 is a diagram of a LCD device according to the second embodiment of the invention.

FIG. 29 is a perspective view of a backlight module according to a third embodiment of the invention.

FIG. 30 is an enlarged view of area A in FIG. 29.

FIG. 31 is a side view of the backlight module in FIG. 29.

FIG. 32 is an enlarged view of area A in FIG. 31.

FIG. 33 is a perspective view of a light guide plate according to the third embodiment of the invention.

FIG. 34 is an enlarged view of area A in FIG. 33.

FIG. 35 is an enlarged view of area B in FIG. 33.

FIG. 36 is an enlarged view of area C in FIG. 33.

FIG. 37 is a diagram of a LCD device according to the third embodiment of the invention.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

### First Embodiment

In first embodiment of the invention, a backlight module including a plurality of light guide plates, a plurality of light emitting devices, and a back frame is provided. The adjacent light guide plates are coupled with each other to form a piece-coupled light guide plate. The piece-coupled light guide plate can be different types, such as a cascading piece-coupled light guide plate or a flat joint piece-coupled light guide plate.

The light emitting devices provide a light to the piece-coupled light guide plate. The light emitting devices can be dot light sources (for example, light emitting diodes (LEDs)) or linear light sources (for example, cold cathode fluorescent lamps (CCFLs)), and which can be disposed according to the type of the piece-coupled light guide plate.

The back frame has a back sheet and a bending element. The back sheet has at least one broken hole. The bending element is disposed near the broken hole and forms an angle with the back sheet. The bending element has a locking groove, and the piece-coupled light guide plate is leaned against the locking groove. The piece-coupled light guide plate and films below the piece-coupled light guide plate can be fastened directly through the bending element of the back frame, so as to ensure a good evenness of the piece-coupled light guide plate and the films below the piece-coupled light guide plate. Thereby, the backlight module can provide a uniform planar light source.

Below, the backlight module will be described with two different types of piece-coupled light guide plates (i.e., cascading piece-coupled light guide plate and flat joint piece-coupled light guide plate). However, the invention is not limited thereto, and other types of piece-coupled light guide plates can also be applied in the invention.

A backlight module with a cascading piece-coupled light guide plate will be described first.

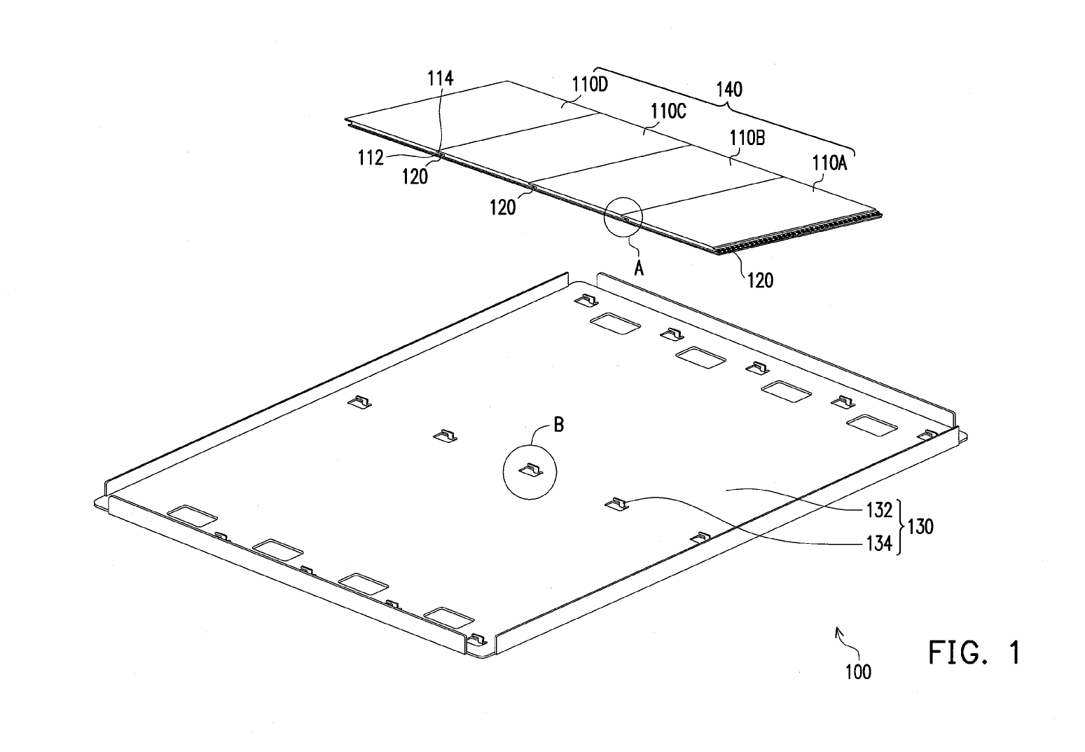

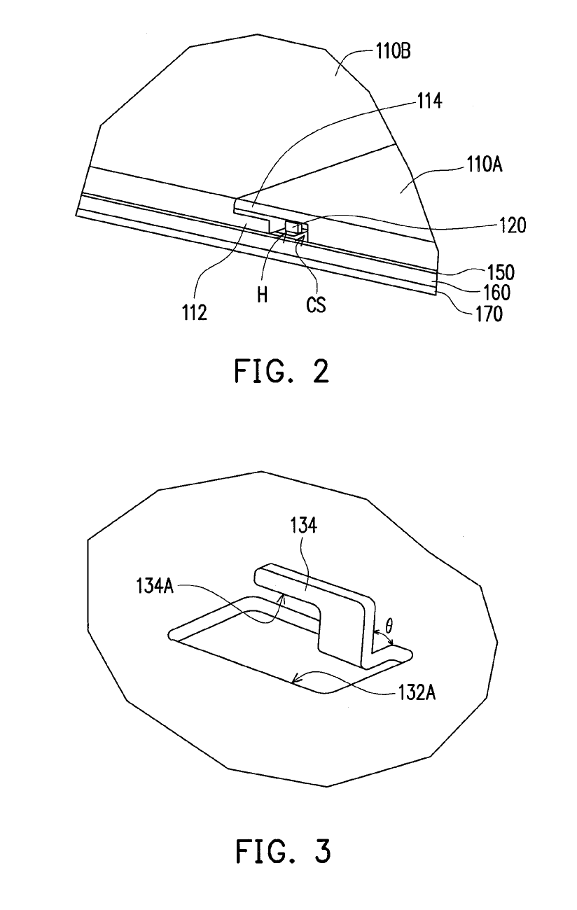

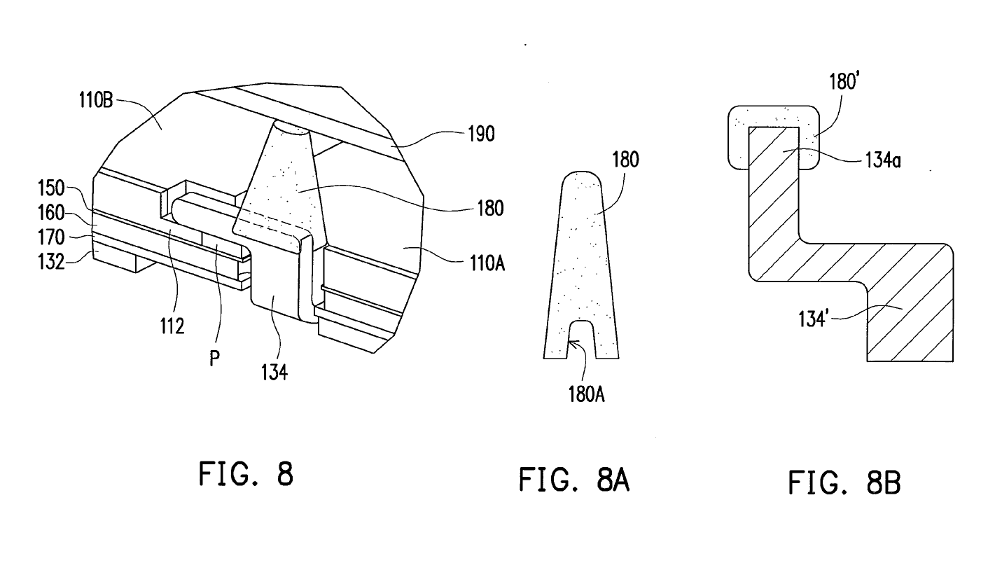

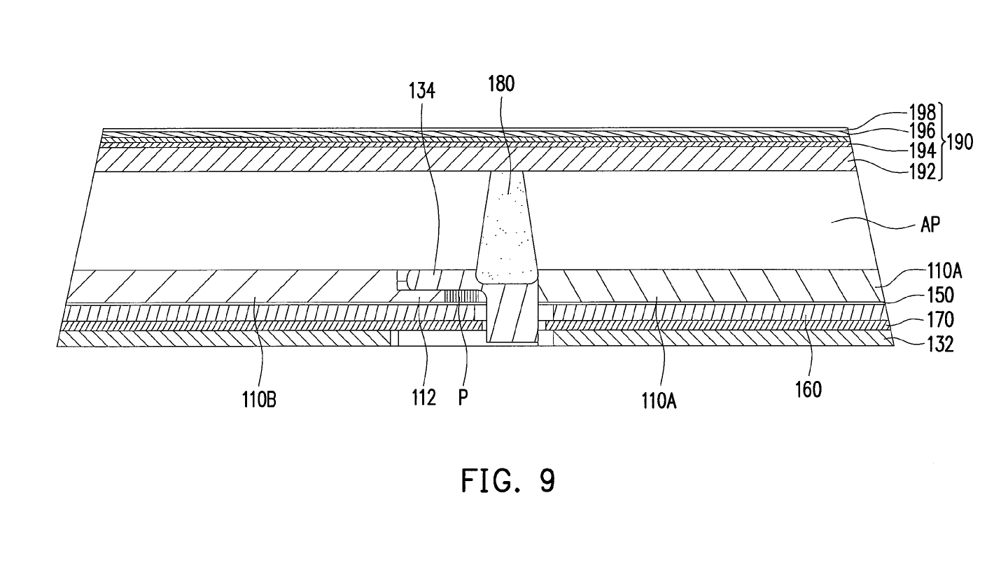

FIG. 1 is a perspective view of a backlight module according to the first embodiment of the invention. FIG. 2 is an enlarged view of area A in FIG. 1. FIG. 3 is an enlarged view of area B in FIG. 1. Referring to FIGS. 1-3, the backlight module 100 includes a plurality of light guide plates 110A-110D, a plurality of light emitting devices 120, and a back frame 130. Each of the light guide plates 110A-110D has a light incidence portion 112 and a coupling portion 114 opposite to each other. Adjacent light incidence portions 112 and coupling portions 114 are coupled with each other to form a piece-coupled light guide plate 140. A containing space CS can be formed at the junction of the light incidence portion 112 and the coupling portion 114. The light emitting devices 120 can be disposed in the containing space CS and located at one side of the light incidence portion 112. The back frame 130 has a back sheet 132 and a bending element 134. The back sheet 132 has a broken hole 132A. The bending element 134 is disposed near the broken hole 132A and forms an angle θ with the back sheet 132. The bending element 134 has a locking groove 134A, and the piece-coupled light guide plate 140 is leaned against the locking groove 134A (also as shown in following FIG. 8 and FIG. 9).

Herein, the piece-coupled light guide plate 140 is assumed to be formed by four light guide plates 110A-110D. However, the number of light guide plates to form the piece-coupled light guide plate 140 is not limited herein, and in other embodiments, the piece-coupled light guide plate 140 can also be formed by other number of light guide plates according to the design requirement.

Referring to FIG. 2, the backlight module 100 may further includes a reflector 150 disposed below the piece-coupled light guide plate 140 (i.e., the light guide plates 110A and 110B in FIG. 2). The reflector 150 has a hole H corresponding to the light emitting devices 120, and the light emitting devices 120 can pass through the hole H. The hole H can be in a stripe shape such that all the light emitting devices 120 can pass through the reflector 150. Or, there can be multiple holes H respectively corresponding to the light emitting devices 120.

The backlight module 100 further includes a circuit board 160 disposed below the reflector 150. The light emitting devices 120 is electrically connected to the circuit board 160, and the reflector 150 is located between the circuit board 160 and the piece-coupled light guide plate 140. Electricity is supplied to the light emitting devices 120 through the circuit board 160 to allow the light emitting devices 120 to emit light. A control circuit (not shown) on the circuit board 160 performs local dimming control on the light emitting devices 120 to allow light to enter all or part of the light guide plates 110A-110D. The light emitting devices 120 may be LEDs, organic light-emitting diodes (OLEDs), or other dot light sources with similar characteristics.

The backlight module 100 may further includes an insulation layer 170 disposed below the circuit board 160, and the circuit board 160 is located between the reflector 150 and the insulation layer 170. The insulation layer 170 electrically insulates the circuit board 160 from external conductive devices (not shown), so that the circuit board 160 and the light emitting devices 120 are protected from the electric discharge effect of the external conductive devices.

As shown in FIG. 3, FIG. 8, and FIG. 9, the piece-coupled light guide plate 140, the reflector 150, the circuit board 160, and the insulation layer 170 can be pressed by the bending element 134 of the back frame 130 to make the piece-coupled light guide plate 140 and the films below the piece-coupled light guide plate 140 become even. This will be explained in detail later on with reference to FIG. 8 and FIG. 9.

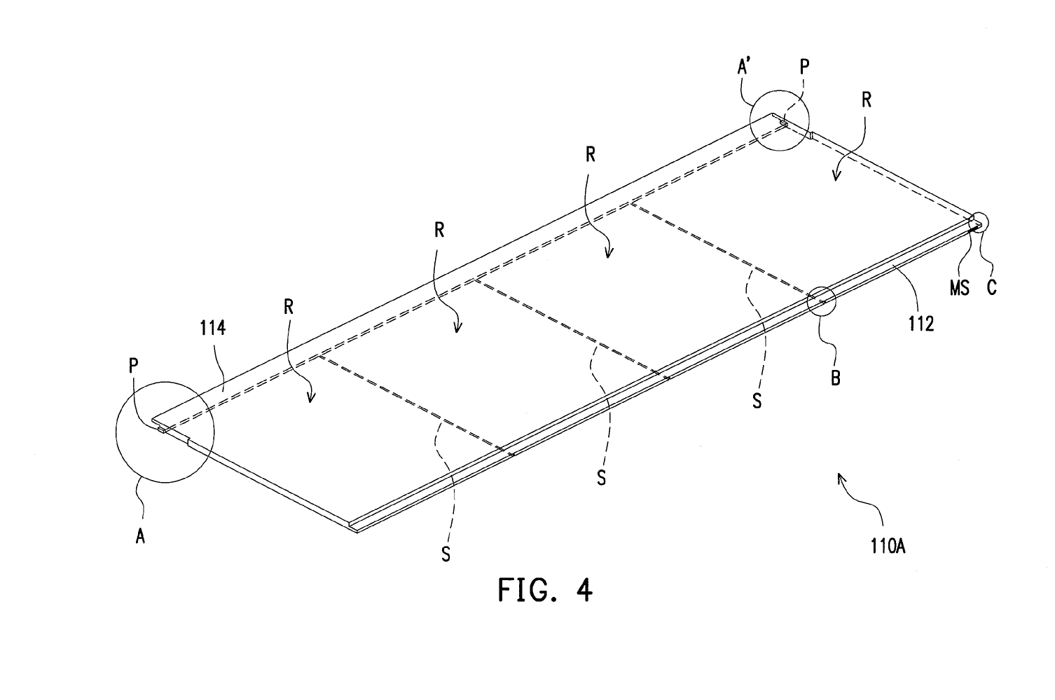

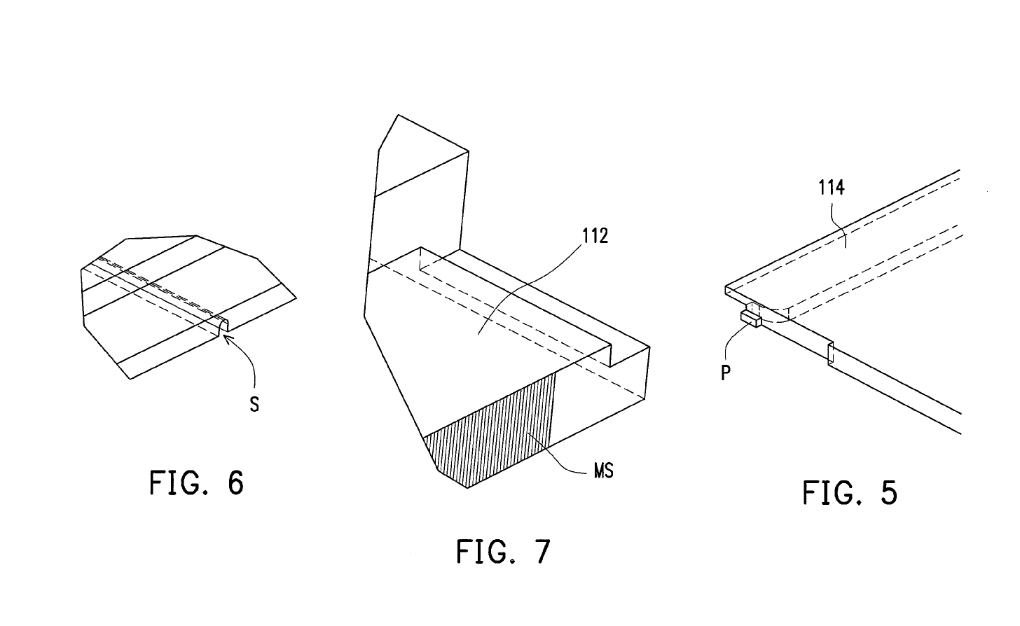

FIG. 4 is a perspective view of a light guide plate according to the first embodiment of the invention. FIG. 5 is an enlarged view of area A in FIG. 4. FIG. 6 is an enlarged view of area B in FIG. 4. FIG. 7 is an enlarged view of area C in FIG. 4.

Herein, a single light guide plate 110A will be described as an example. The structures of the light guide plates 110B-110D are the same as that of the light guide plate 110A. Referring to FIGS. 4-7, the light guide plate 110A has a light incidence portion 112 and a coupling portion 114 opposite to the light incidence portion 112. The light incidence portion 112 and the adjacent coupling portion 114 are coupled with each other to form a piece-coupled light guide plate 140. The light incidence portion 112 and the coupling portion 114 present an interactional cascading style. Also referring to FIG. 2, the light incidence portion 112 is thicker than the coupling portion 114 so that a containing space CS for containing the light emitting devices 120 is formed through cascading drop. After the incidence portion 112 and the coupling portion 114 are coupled with each other, the upper surface of the light plate 110B with the light incidence portion 112 and the upper surface of the light plate 110A with the coupling portion 114 are substantially on the same plane, and the lower surfaces thereof are also substantially on the same plane. In other words, upper and lower surfaces of light guide plates 110A and 110B are substantially on the same plane respectively. Accordingly, the reflector 130 below the piece-coupled light guide plate 140 (as shown in FIG. 2) can be attached to the piece-coupled light guide plate 140 more evenly.

As shown in FIG. 4 and FIG. 6, the light guide plate 110A can has a plurality of trenches S. The trenches S divide the light guide plate 110A into a plurality of light emitting areas R. The trenches S isolate light in different light emitting areas R so that the light emitting areas R can emit light all at once or at different time. The trenches S can be formed when the light guide plate 110A is injection molded or by using a trenching tool (not shown).

As shown in FIG. 4 and FIG. 7, a microstructure MS can be disposed at one side of the light incidence portion 112 of the light guide plate 110A. The microstructure MS may be a plurality of micro-trenches. The microstructure MS is disposed to facilitate the entrance of the light emitted by the light emitting devices 120 disposed at the sides of the light incidence portion 112 into the light guide plate 110A, so as to improve the light use efficiency.

As shown in FIGS. 3-5, there is at least a protrusion P at one side of the coupling portion 114 of the light guide plate 110A, and the protrusion P is leaned against the locking groove 134A. In addition, another protrusion P can be further formed within the area A′ in FIG. 4 (corresponding to the area A). The piece-coupled light guide plate 140 can be properly fastened by leaning the protrusion P against the locking groove 134A of the bending element 134. Thereby, the piece-coupled light guide plate 140 and the reflector 150, the circuit board 160, and the insulation layer 170 below the piece-coupled light guide plate 140 can be well fastened to the back frame 130 and accordingly the problem of warping is resolved.

The bending element 134 in FIG. 3 may be formed by punching and bending the back sheet 132. In the back frame 130 illustrated in FIG. 1, a plurality of bending elements 134 is formed at a plurality of predetermined positions on the back sheet 132 to fix a plurality of positions on the piece-coupled light guide plate 140. Below, the coupling state between the bending element 134 and the protrusion P will be further explained with reference to FIG. 8 and FIG. 9.

FIG. 8 is a perspective view of a backlight module according to the first embodiment of the invention. FIG. 8A is a diagram of a cushion element according to the first embodiment of the invention. FIG. 8B is a diagram of another bending element according to the first embodiment of the invention. FIG. 9 is a cross-sectional view of a backlight module according to the first embodiment of the invention.

Referring to FIG. 1, FIG. 3, FIG. 8, and FIG. 9, it is assumed that the bending element 134 is leaned against the light guide plate 110A and the light guide plates 110B which are coupled with each other. The protrusion P at one side of coupling portion 114 of the light guide plate 110A is connected with the light incidence portion 112 of the light guide plates 110B, and the bending element 134 is leaned against both the protrusion P of the light guide plate 110A and the light incidence portion 112 of the light guide plates 110B. Accordingly, the light guide plate 110A and the light guide plates 110B form an even piece-coupled light guide plate 140.

Referring to FIG. 8 and FIG. 9, the backlight module 100 may further includes a cushion element 180 disposed on the bending element 134. The backlight module 100 may further includes an optical plate assembly 190 leaned against the cushion element 180. As shown in FIG. 8A, the cushion element 180 has a connecting groove 180A, and the connecting groove 180A allows the cushion element 180 to be directly locked onto the bending element 134. The cushion element 180 can be made of a flexible material to reduce the impact between the optical plate assembly 190 and the piece-coupled light guide plate 140 (i.e., the light guide plates 110A and 110B in FIG. 8 and FIG. 9). The optical plate assembly 190 can be a combination of any optical film, such as a diffuser 192, a prism sheet 194, a brightness enhancement film 196, and a protector sheet 198.

As shown in FIG. 9, the cushion element 180 has an appropriate height such that the cushion element 180 on the bending element 134 produces an air gap AP between the piece-coupled light guide plate 140 and the optical plate assembly 190. Accordingly, an appropriate light mixing distance is provided to the light emitted from the piece-coupled light guide plate 140 and a uniform planar light source can be achieved. FIG. 8B illustrates another bending element 134′. The bending element 134′ further has a protruding portion 134a for carrying the optical plate assembly 190. Besides, a cushion element 180′ can be simply sleeved on the protruding portion 134a.

In the backlight module with the cascading piece-coupled light guide plate described above, the cascading piece-coupled light guide plate and the films below the cascading piece-coupled light guide plate can be fastened by using the bending element of the back sheet, so as to allow the backlight module to provide a uniform planar light source.

A backlight module with a flat joint piece-coupled light guide plate will be described herein.

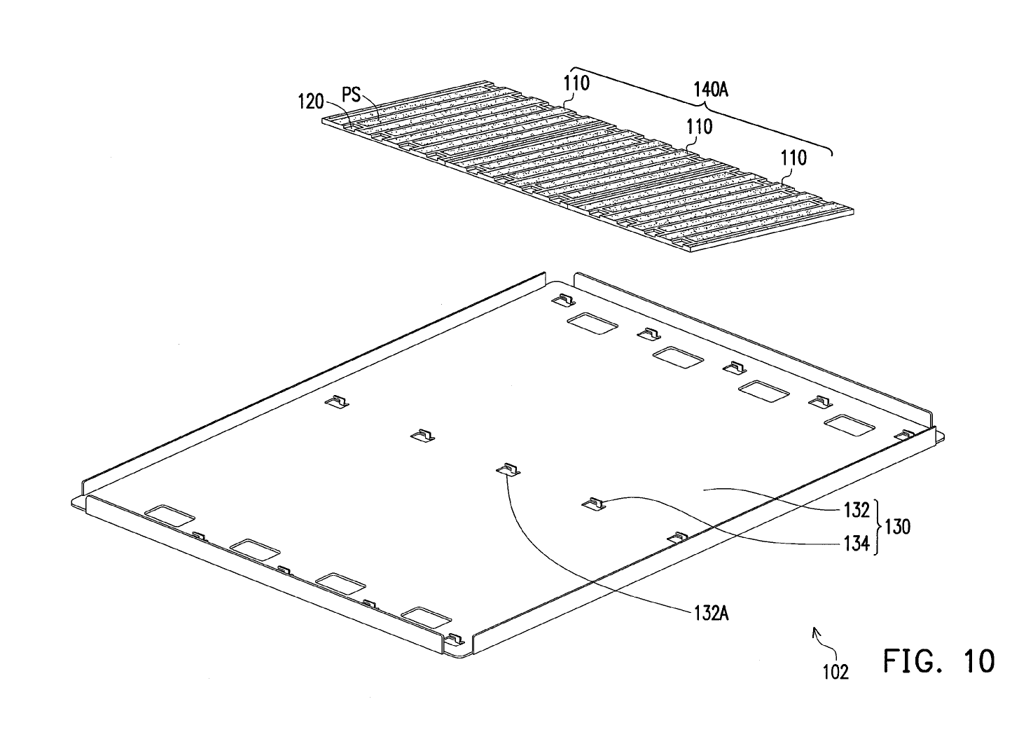

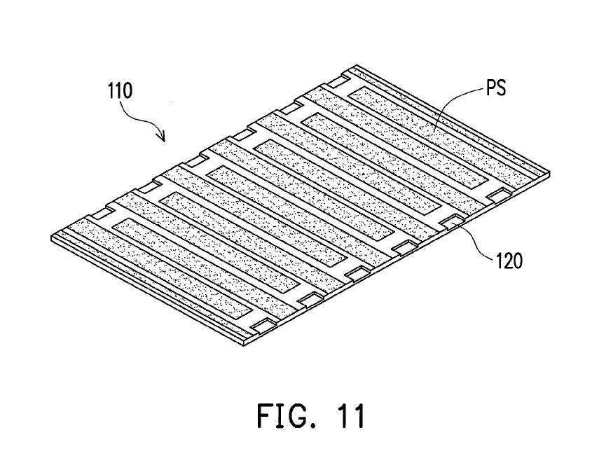

FIG. 10 is a perspective view of another backlight module according to the first embodiment of the invention. Referring to FIG. 10, the backlight module 102 includes a plurality of light guide plates 110, a plurality of light emitting devices 120, and a back frame 130. The adjacent light guide plates 110 are coupled with each other to form a piece-coupled light guide plate 140A. The light emitting devices 120 are disposed at least one side of the piece-coupled light guide plate 140A. The back frame 130 has a back sheet 132 and a bending element 134. The back sheet 132 has a broken hole 132A. The bending element 134 is disposed near the broken hole 132A and forms an angle θ with the back sheet 132. The bending element 134 has a locking groove 134A, and the piece-coupled light guide plate 140A is leaned against the locking groove 134A (also as shown in FIG. 3).

Similar to the backlight module 100, the backlight module 102 also includes aforementioned cushion elements 180 and 180′, optical plate assembly 190, reflector 150, circuit board 160, and insulation layer 170. Herein, the same components will be not described. The difference between the two backlight modules is that the backlight module 100 has a cascading piece-coupled light guide plate 140, while the backlight module 102 has a flat joint piece-coupled light guide plate 140A. As shown in FIG. 10, coupling sides of the adjacent light guide plates 110 contact each other to form the piece-coupled light guide plate 140A. The light guide plates 110 can be in a rectangular shape, and each side of the light guide plates 110 is polished and served as a coupling side.

FIG. 11 is a diagram of a light guide plate according to the first embodiment of the invention. Referring to FIG. 11, rows of optical structures PS are disposed on the surface of each light guide plate 110 and extended in parallel. The optical structures PS on the light guide plates 110 are arranged in parallel at equal distances or unequal distances (not shown).

The light emitting devices 120 are disposed at least one end (only one end or both ends) of each optical structure PS so that the light emitting devices 120 can emit light in the direction parallel to the extension direction of the optical structure PS. Thus, the luminosity produced within the stripe-shaped areas of the optical structures PS is much higher than that produced in other areas without the optical structures, and accordingly, after coupling a lots of light guide plate 110, an inerratic but non-uniform light emitting effect can be achieved by the entire piece-coupled light guide plate 140A.

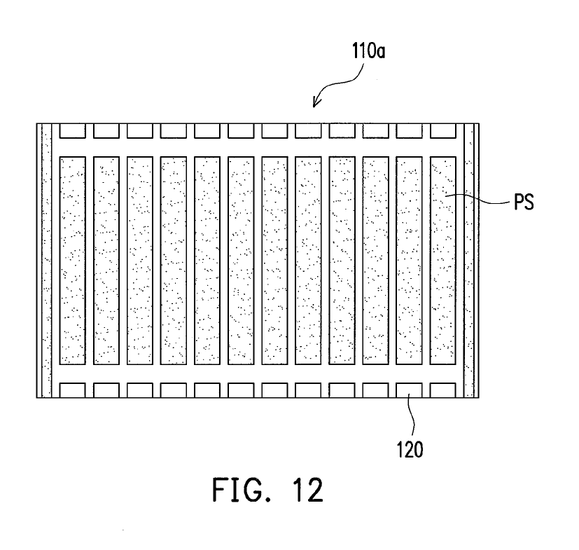

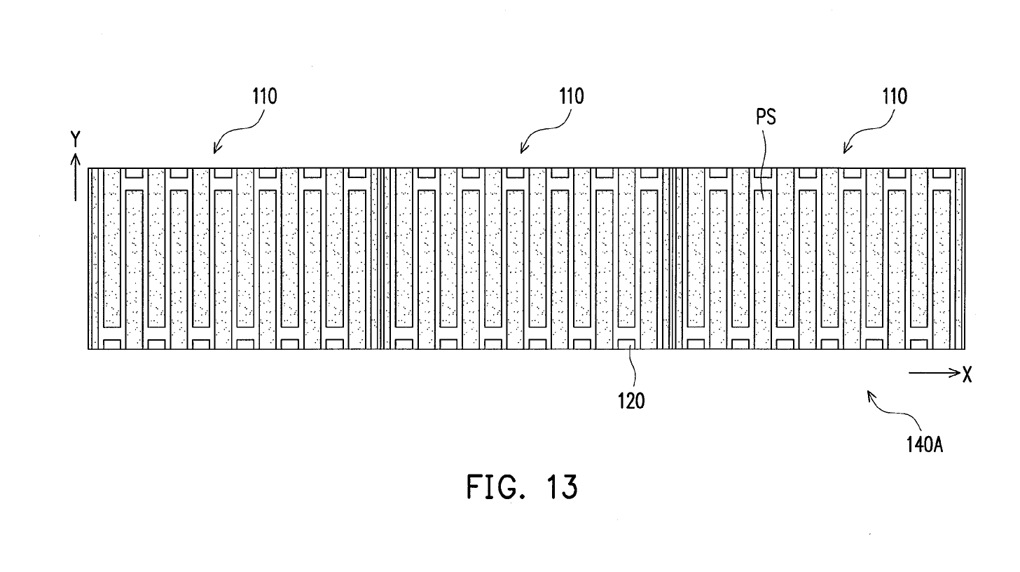

The light emitting devices 120 may be LEDs, and the light emitting devices 120 disposed at one ends of two adjacent rows of optical structures PS can be located opposite to each other. FIG. 12 is a diagram of another light guide plate according to the first embodiment of the invention. Referring to FIG. 11 and FIG. 12, besides alternatively disposing the light emitting devices 120 at two opposite sides of the light guide plates 110 (as shown in FIG. 11), the light emitting devices 120 can also be symmetrically disposed at two opposite sides of the light guide plates 110a, and light emitting devices 120 emits light to both ends of the optical structures PS (as shown in FIG. 12).

The optical structures PS may be a plurality of protrusions on the surfaces of the light guide plates 110, a plurality of dents on the surfaces of the light guide plates 110, or a combination of protrusions and dents. The protrusions or dents can be distributed in a lower density at where it is closer to the light emitting devices 120 and in a higher density at where it is farther away from the light emitting devices 120. Through such a distribution, the protrusions or dents can reflect and refract more light at where it is farther away from the light emitting devices 120 and less light at where it is closer to the light emitting devices 120, so that the entire optical structure PS can provide a uniform luminosity.

Additionally, according to the design requirement, each row of optical structures PS can be made to have the same optical properties, so that the optical structures PS can present an identical luminosity after light enters the optical structures PS. Or, each row of optical structures PS can also be made to have different optical properties, so that the optical structures PS can present different luminosities after light enters the optical structures PS.

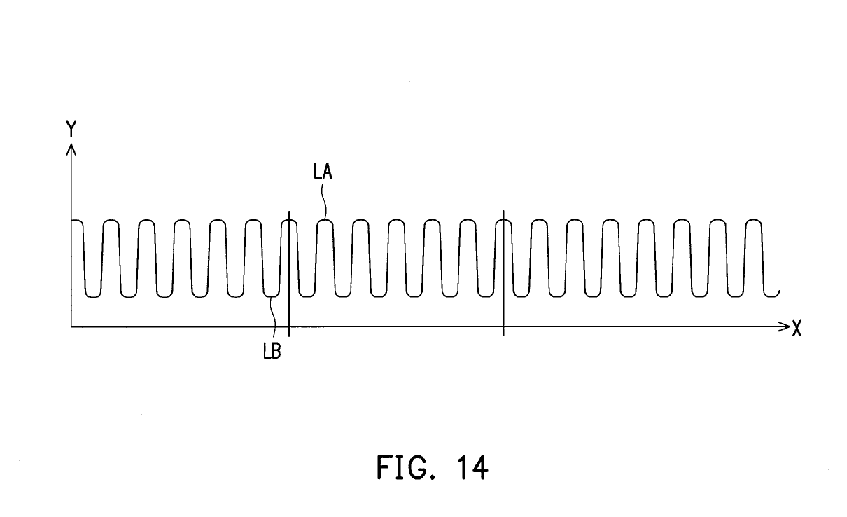

FIG. 13 is a diagram of a plurality of light guide plates in FIG. 11 coupled together along a direction X. FIG. 14 is a luminosity graph corresponding to the piece-coupled light guide plate in FIG. 13. Referring to both FIG. 13 and FIG. 14, in the piece-coupled light guide plate 140A, the light emitting devices 120 emit light in the direction Y (i.e., the direction parallel to the extension direction of the optical structures PS) so that the area of each optical structure PS produces a high luminosity while the areas without the optical structures PS produce low luminosities or darkness (as shown in FIG. 14, L_{A} is a high luminosity area, and L_{B} is a low luminosity area). As described above, the bright lines produced at the coupling sides of two adjacent light guide plates 110 due to light refraction are mixed with the luminosity of the areas with the optical structures PS, therefore cannot be distinguished by human eyes. Thereby, the problem of bright lines is resolved.

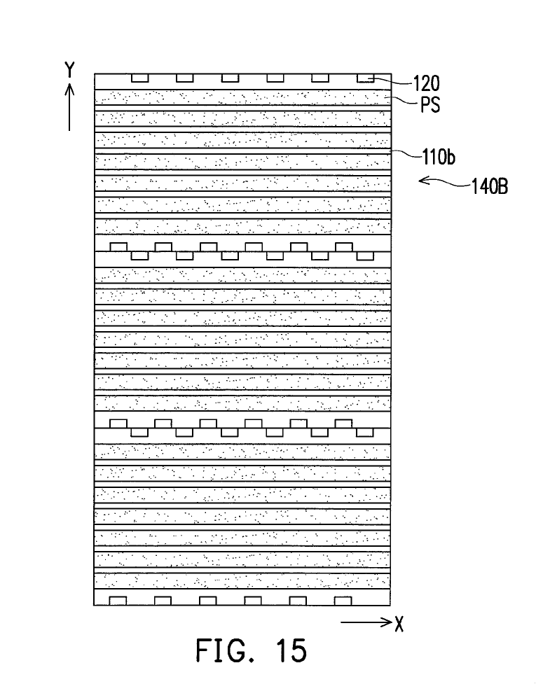

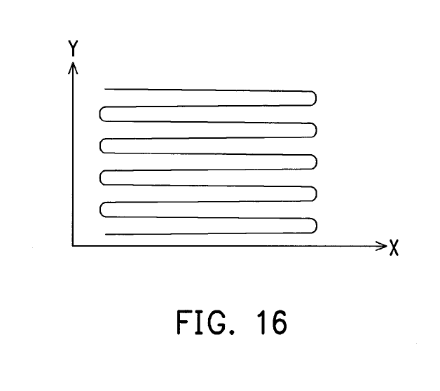

FIG. 15 is a diagram of another flat joint piece-coupled light guide plate according to the first embodiment of the invention, wherein a plurality of light guide plates 110b are coupled with each other along the direction Y. FIG. 16 is a luminosity graph corresponding to the piece-coupled light guide plate in FIG. 15.

Referring to FIG. 13 and FIG. 15, in the piece-coupled light guide plate 140A illustrated in FIG. 13, the light emitting devices 120 emit light in a direction parallel to the extension direction of the optical structures PS, while in the piece-coupled light guide plate 140B illustrated in FIG. 15, the light emitting devices 120 emit light in the direction perpendicular to the extension direction of the optical structures PS.

Additionally, as shown in FIG. 15, the light emitting devices 120 emit light in the direction Y (i.e., the direction perpendicular to the extension direction of the optical structures PS) so that the area of each optical structure PS produces a high luminosity and the areas without the optical structures PS produce lower luminosities or even darkness (please refer to the luminosity graph in FIG. 16). Accordingly, the bright lines produced at the coupling sides of adjacent two light guide plates 110b are mixed with the luminosities produced by the areas of the optical structures PS, therefore cannot be distinguished by human eyes. Thereby, the problem of bright lines is resolved.

As described above, in the backlight module 102 with the flat joint piece-coupled light guide plate 140A or 140B, the flat joint piece-coupled light guide plate 140A or 140B and the films below the flat joint piece-coupled light guide plate 140A or 140B are also fastened by using the bending element 134 of the back frame 130, so as to allow the backlight module 102 to provide a uniform planar light source.

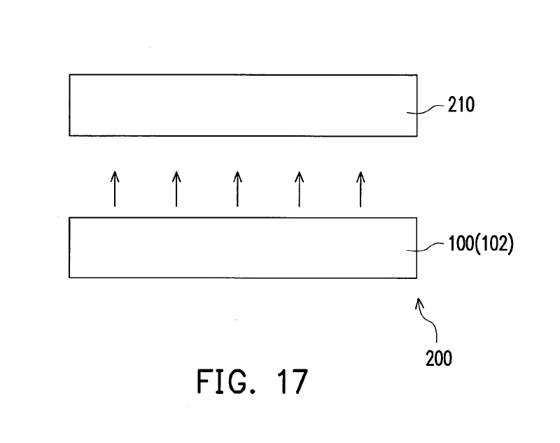

FIG. 17 is a diagram of a liquid crystal display (LCD) device according to the first embodiment of the invention. Referring to FIG. 17, the LCD device 200 includes the backlight module 100 (or 102) described above and a LCD panel 210. The LCD panel 210 is disposed at one side of the backlight module 100 (or 102). Because the LCD device 200 has the backlight module 100 (or 102), it offers a good image quality. In particular, because the backlight module 100 (or 102) adopts the piece-coupled light guide plate 140 (or 140A), it is most suitable for large-sized LCD TVs.

According to the first embodiment, the backlight module and the LCD device directly adopt a bending element formed by bending part of the back frame such that the piece-coupled light guide plate can be properly leaned against the locking groove of the bending element to fasten the piece-coupled light guide plate. Thereby, an even piece-coupled light guide plate can be achieved and accordingly the backlight module can provide a uniform planar light source. In addition, the protrusions on the light guide plates are locked with the bending element for better fasten. Moreover, the optical plate assembly is carried by using the protrusions on the bending element or a cushion element to form an air gap between the piece-coupled light guide plate and the optical plate assembly, so that a proper light mixing distance is produced in the backlight module and a more uniform planar light source can be achieved.

### Second Embodiment

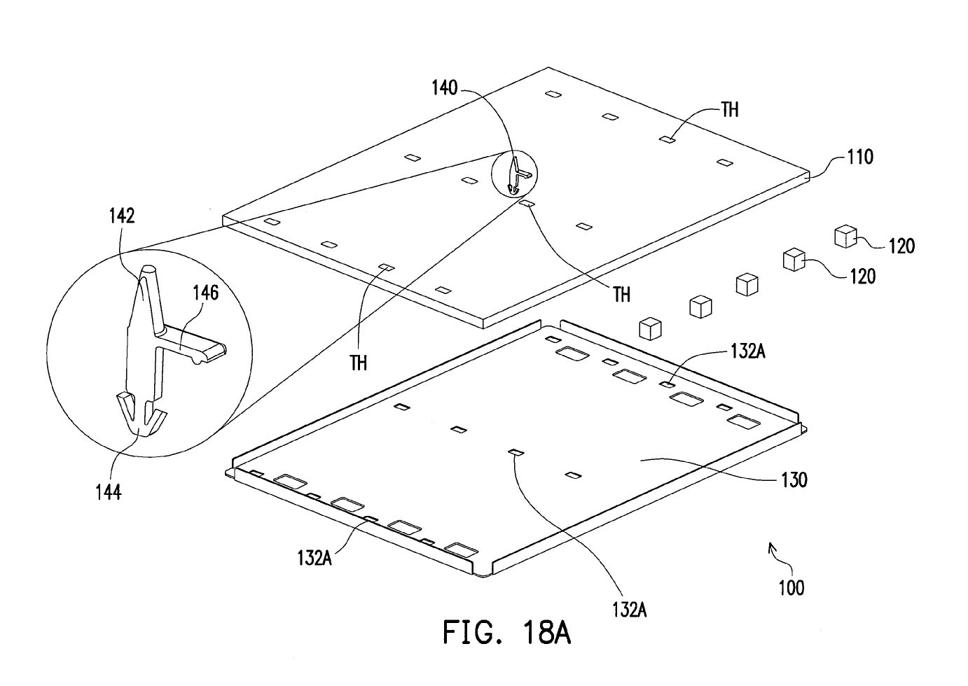

FIG. 18A is a perspective view of some components of a backlight module according to the second embodiment of the invention. Referring to FIG. 18A, the backlight module 100 includes a light guide plate 110, a plurality of light emitting devices 120, a back frame 130, and a supporting and fastening device 140. The light guide plate 110 has at least one through hole TH. The light emitting devices 120 are disposed on one side of the light guide plate 110. The back frame 130 has at least one broken hole 132A, wherein the position of the broken hole 132A is corresponding to the position of the through hole TH. The light guide plate 110 and the light emitting devices 120 are disposed within the back frame 130. The supporting and fastening device 140 has a body 142, a fastening portion 144, and a pressing portion 146. The fastening portion 144 is connected to one end of the body 142, and the pressing portion 146 is connected to one side of the body 142, wherein the fastening portion 144 and part of the body 142 pass through the through hole TH of the light guide plate 110 and the broken hole 132A of the back frame 130. The fastening portion 144 is locked to the back frame 130. The pressing portion 146 presses the light guide plate 110.

FIG. 18A is a partial cross-sectional view of the supporting and fastening device 140, wherein the coupling relationship between the body 142, the fastening portion 144, and the pressing portion 146 is illustrated. Herein, it is assumed that there is only one pressing portion 146. However, the number and disposed positions of the pressing portion 146 can be adjusted according to the design requirement.

FIG. 18B is a perspective view of some components of another backlight module according to the second embodiment of the invention. Like reference numerals refer to the like elements throughout FIG. 18B and FIG. 18A. It should be noted that there are two pressing portions 146, and the two pressing portions 146 are connected to both sides of the body 142. The two pressing portions 146 can press the light guide plate 110 more efficiently. However, there may be any suitable number of pressing portions 146.

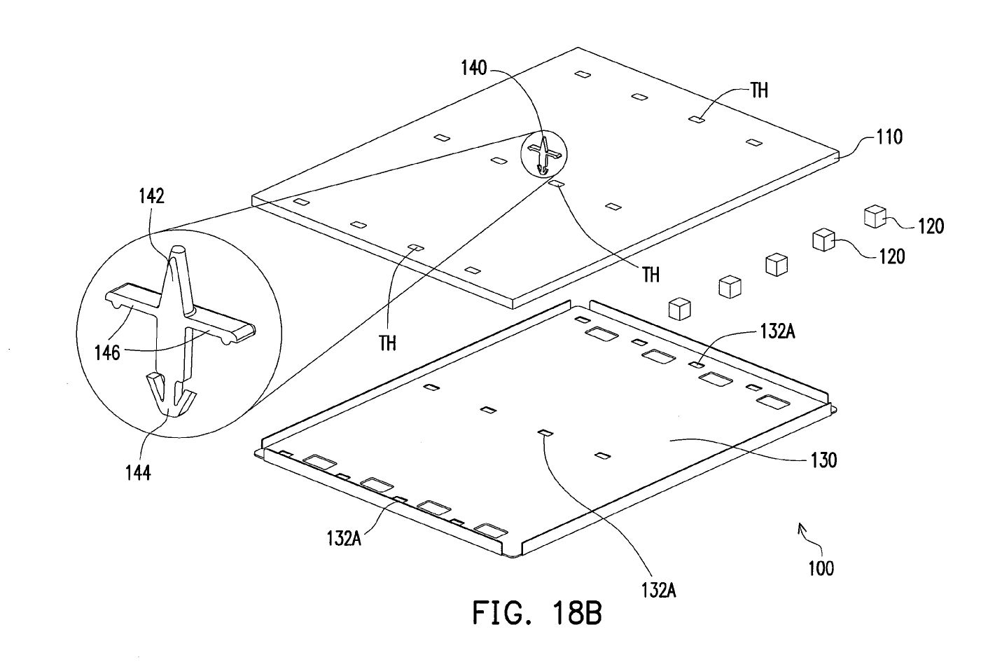

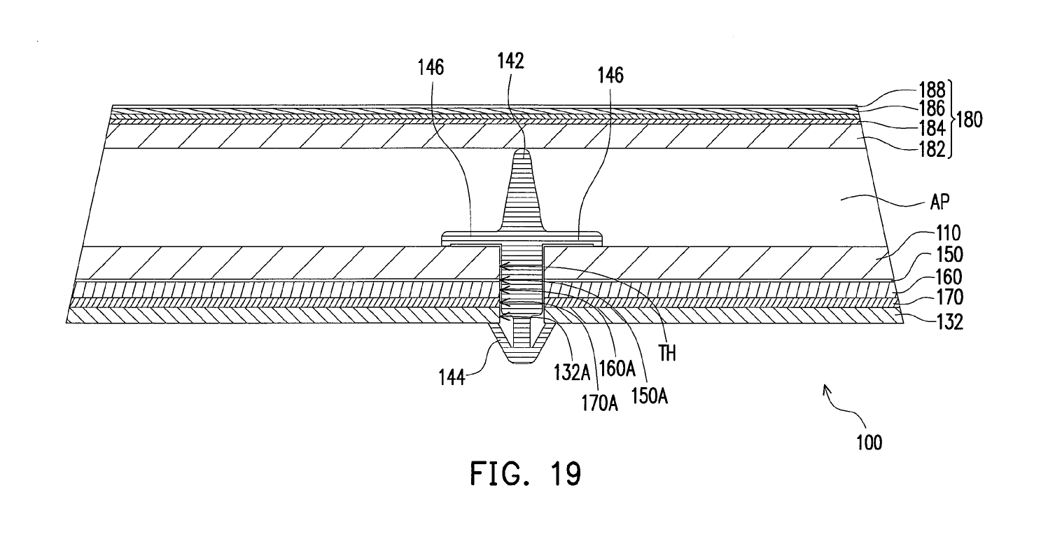

As shown in FIG. 18A, the light guide plate 110 is a single plate and has a plurality of through holes TH. The positions of the through holes TH are corresponding to the positions of the broken holes 132A. The light guide plate 110 and the back frame 130 can be easily connected with each other by passing the supporting and fastening device 140 through the through holes TH and the broken holes 132A. In addition, the body 142 of the supporting and fastening device 140 further carry the optical films above the supporting and fastening device 140 (as shown in FIG. 19).

FIG. 19 is a cross-sectional view of the backlight module in FIG. 18B. Referring to FIG. 18B and FIG. 19, in the backlight module 100, optical films and a circuit board are further disposed below the light guide plate 110. Namely, the backlight module 100 includes a reflector 150, a circuit board 160, and an insulation layer 170. Besides, an optical plate assembly 180 is further disposed above the light guide plate 110, and the optical plate assembly 180 is leaned against the body 142. The optical plate assembly 180 can be a combination of any optical film, such as a diffuser 182, a prism sheet 184, a brightness enhancement film 186, and a protector sheet 188.

Referring to FIG. 19, the reflector 150 is disposed below the light guide plate 110 for reflecting the light emitted by the light emitting devices 120 upwards. The circuit board 160 is disposed below the reflector 150. The light emitting devices 120 is electrically connected to the circuit board 160. The reflector 150 is located between the circuit board 160 and the light guide plate 110. The circuit board 160 controls the on/off of the light emitting devices 120. The insulation layer 170 is disposed below the circuit board 160. The circuit board 160 is located between the reflector 150 and the insulation layer 170. The insulation layer 170 protects the circuit board 160 from electric discharge of external conductive devices (not shown).

Similarly, through holes 150A, 160A, and 170A are respectively disposed at positions corresponding to the through holes TH and the broken holes 130A on the reflector 150, the circuit board 160, and the insulation layer 170, so that the supporting and fastening device 140 can also pass through the reflector 150, the circuit board 160, and the insulation layer 170.

Because the body 142 has a suitable height, an air gap AP is formed between the light guide plate 110 and the optical plate assembly 180. Thus, a proper light mixing distance is provided to the light emitted by the light guide plate 110 and accordingly a uniform planar light source can be achieved.

As described above, besides fastening the light guide plate 110 and the optical films (the reflector 150, the circuit board 160, and the insulation layer 170) below the light guide plate 110 to ensure the evenness of the light guide plate 110 and these optical films, the optical plate assembly 180 can be supported by the body 142 of the supporting and fastening device 140, so as to form the air gap AP and provide a proper light mixing distance. Accordingly, the backlight module 100 can provide a very uniform planar light source.

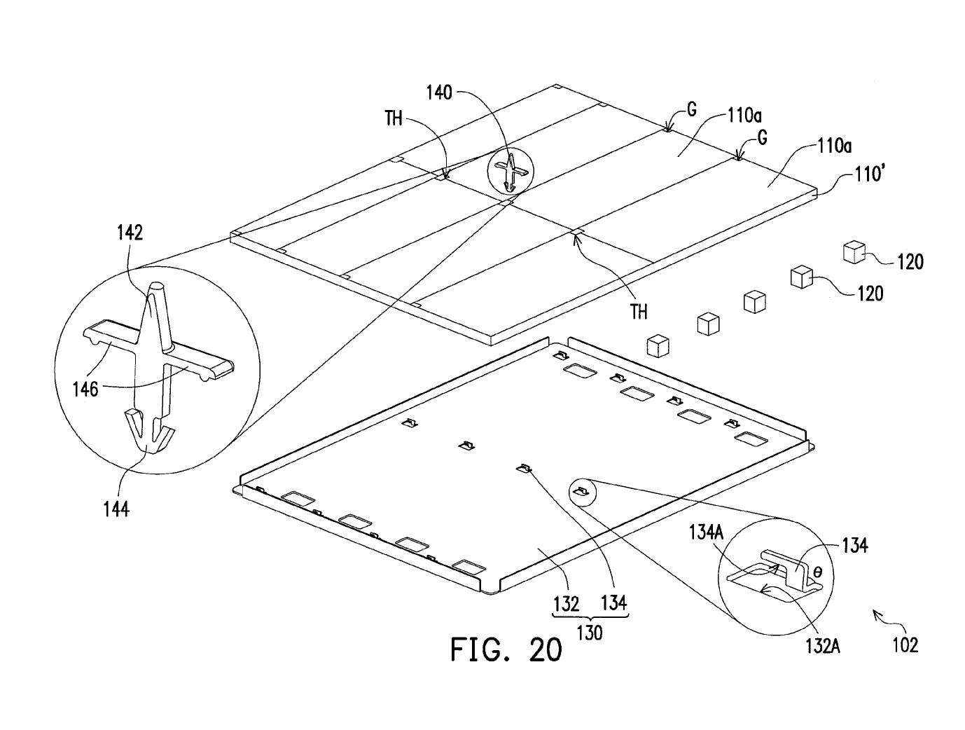

FIG. 20 is a diagram of another backlight module according to the second embodiment of the invention. Referring to FIG. 20, the backlight module 102 illustrated in FIG. 20 is similar to the backlight module 100 illustrated in FIG. 18B. However, the two backlight modules have two differences. The first difference is that the backlight module 100 in FIG. 18B has a single light guide plate 110, while the light guide plate 110′ in the backlight module 102 in FIG. 20 is a piece-coupled light guide plate. The second difference is that the back frame 130 of the backlight module 100 in FIG. 18B has only the broken holes 132A, while the back frame 130 of the backlight module 102 in FIG. 20 further has the bending element 134.

Regarding the first difference, the light guide plate 110′ is a piece-coupled light guide plate composed of a plurality of light guide plates 110a. A recess G is formed at least one corner of each light guide plate 110a, and a plurality of through holes TH is formed by the recesses G of the light guide plates 110a. These through holes TH allow the supporting and fastening device 140 to pass through so that the supporting and fastening device 140 can fasten the light guide plate 110′ onto the back frame 130.

Regarding the second difference, in the backlight module 102, the back frame 130 includes a back sheet 132 and a bending element 134. The back sheet 132 has a broken hole 132A. The bending element 134 is disposed near the broken hole 130A and forms an angle θ with the back sheet 132. The bending element 134 has a locking groove 134A. The light guide plate 110′ is leaned against the locking groove 134A, and two pressing portions 146 press the light guide plate 110′. Namely, the light guide plate 110′ is properly fastened within the back frame 130 by using the bending element 134 of the back frame 130 along with the supporting and fastening device 140.

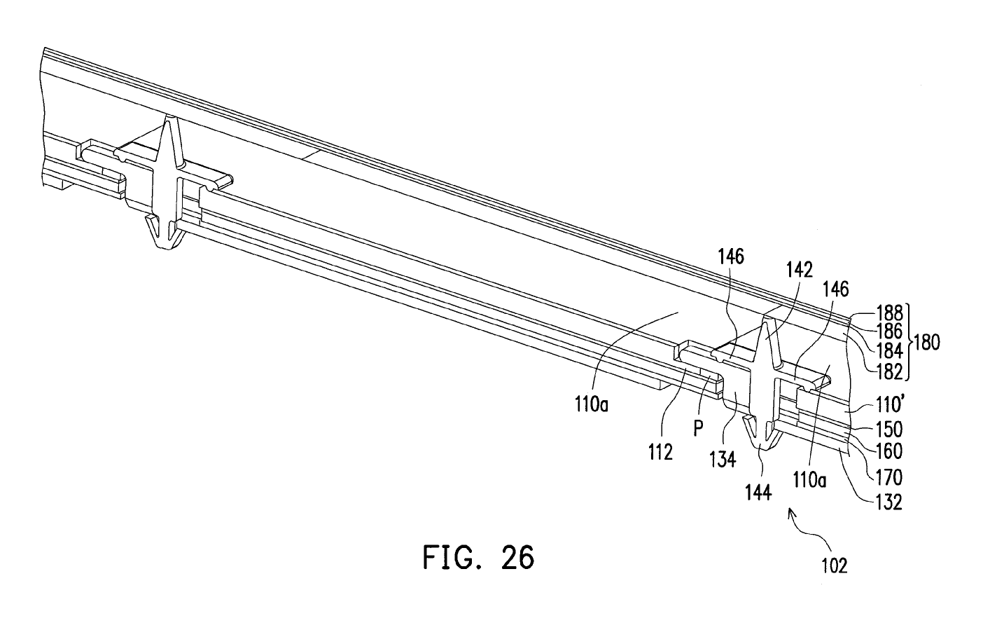

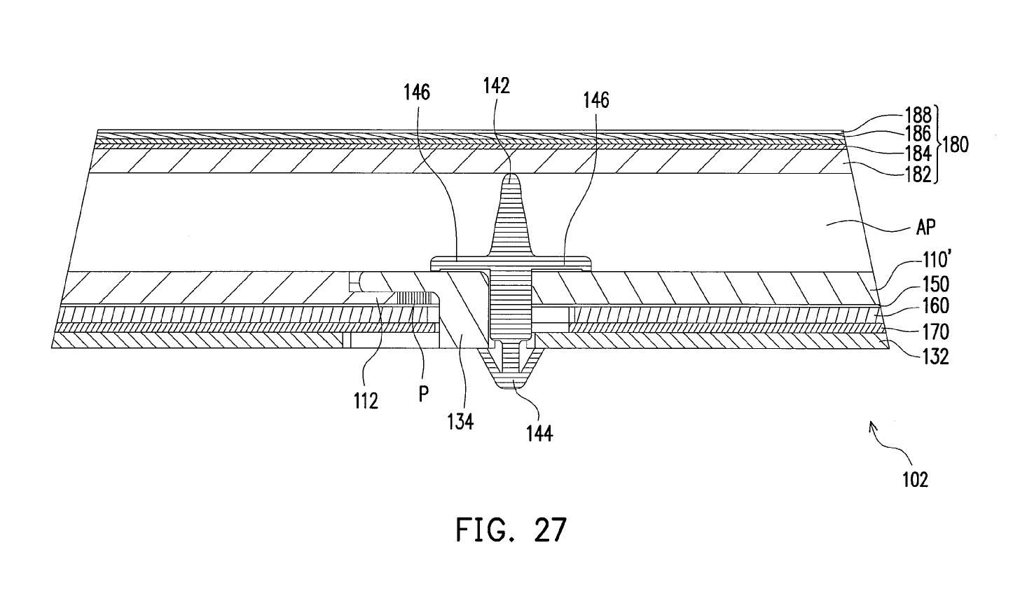

The bending element 134 may be fabricated by punching and bending the back sheet 132. As shown in FIG. 20, the bending element 134 is fabricated at several predetermined positions on the back sheet 132 for fastening several positions of the light guide plate 110′. Later on, the coupling between the bending element 134, the supporting and fastening device 140, and the light guide plate 110′ will be further explained with reference to FIG. 26 and FIG. 27.

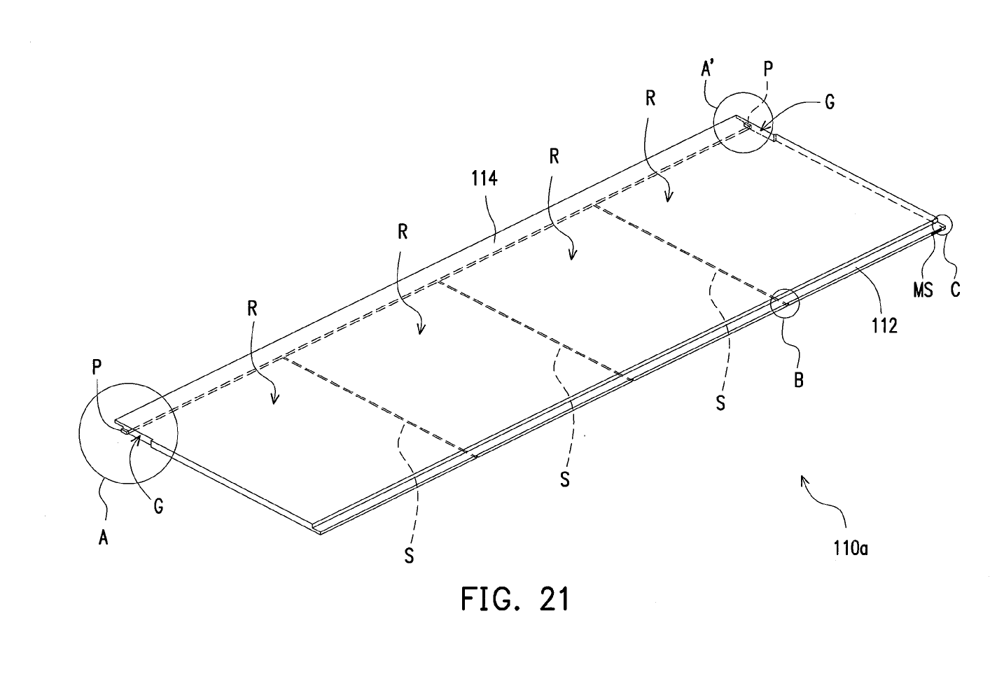

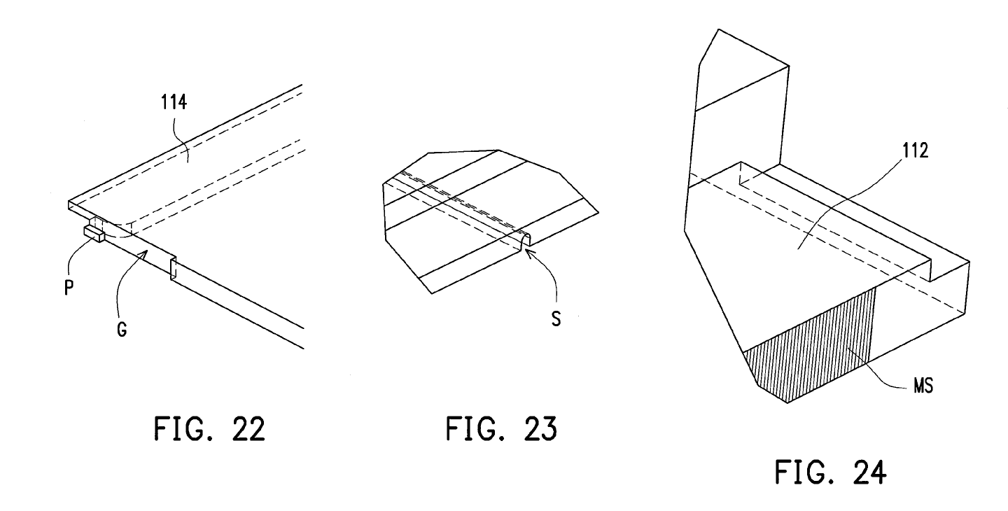

FIG. 21 is a perspective view of a light guide plate according to the second embodiment of the invention. FIG. 22 is an enlarged view of area A in FIG. 21. FIG. 23 is an enlarged view of area B in FIG. 21. FIG. 24 is an enlarged view of area C in FIG. 21.

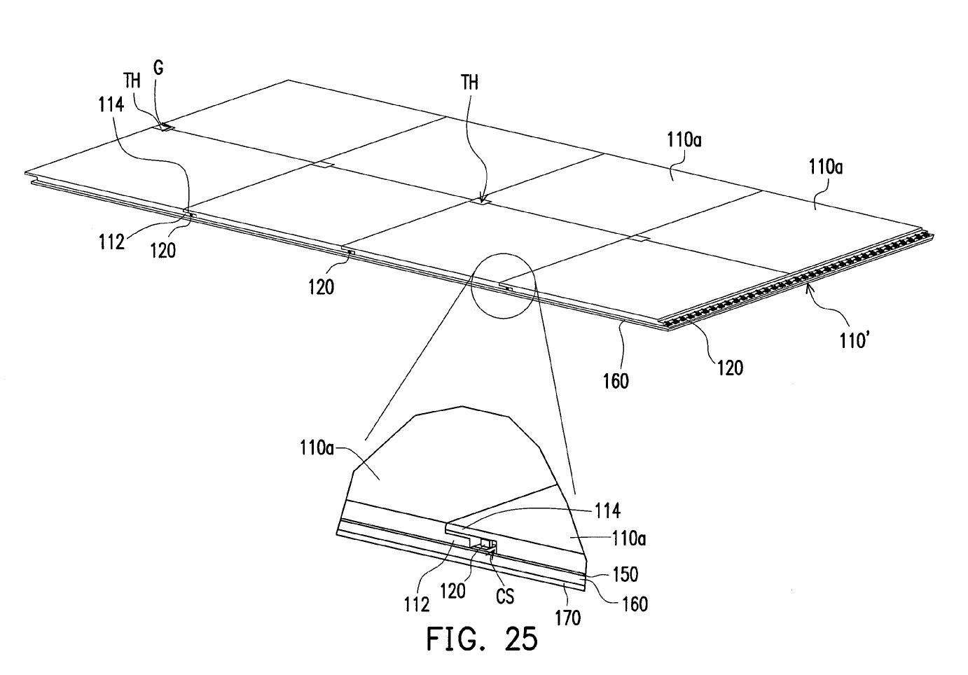

Referring to FIG. 21, each light guide plate 110a has a light incidence portion 112 and an opposite coupling portion 114. The adjacent light incidence portions 112 and coupling portions 114 are coupled with each other to form a piece-coupled light guide plate 110′ (as shown in FIG. 20 and FIG. 25). The light incidence portion 112 and the coupling portion 114 present an interactional cascading style. After the light incidence portions 112 and the coupling portions 114 are coupled together, the upper surface of the light plate 110a with the light incidence portions 112 and the upper surface of the light plate 110a with the coupling portions 114 are substantially on the same plane, and the lower surfaces thereof are also substantially on the same plane. Thereby, the reflector 150, the circuit board 160, and the insulation layer 170 can be evenly disposed below the piece-coupled light guide plate 110′.

It can be understood by referring to the bending element 134 in FIG. 20, the light guide plates 110a in FIG. 21, and the protrusion P in FIG. 22 that there is at least a protrusion P at a side of the coupling portion 114 of the light guide plate 110′ (i.e., the light guide plates 110a), and the protrusion P is leaned against the locking groove 134A. Another protrusion P can be further fabricated within the area A′ (corresponding to the area A) in FIG. 21. The protrusion P is leaned against the locking groove 134A of the bending element 134. In addition, it can be observed in FIG. 21 and FIG. 22 that a recess G is formed at least one corner of the light guide plate 110a, and recesses G are formed within both the areas A and A′. When a plurality of light guide plates 110a is coupled with each other, the recesses G of different light guide plates 110a are coupled with each other to form the through holes TH, so as to allow the supporting and fastening device 140 to pass through.

Referring to FIG. 21 and FIG. 23, the light guide plate 110′ (i.e., the light guide plates 110a) has a plurality of trenches S. The trenches S divide the light guide plate 110′ (i.e., the light guide plates 110a) into a plurality of light emitting areas R. The trenches S isolate light within different light emitting areas R so that the light emitting areas R can emit light all at once or at different time. The trenches S can be formed when the light guide plate 110A is injection molded or by using a trenching tool (not shown).

Referring to FIG. 21 and FIG. 24, a microstructure MS is disposed at one side of the light incidence portion 112 of the light guide plate 110′ (i.e., the light guide plates 110a). The microstructure MS may be a plurality of micro-grooves. The microstructure MS is disposed to facilitate the entrance of the light emitted by the light emitting devices 120 disposed at the sides of the light incidence portions 112 into the light guide plate 110′, so as to improve the light use efficiency.

FIG. 25 is a perspective view of the piece-coupled light guide plate in FIG. 20. Referring to FIG. 25, each light guide plate 110a has a light incidence portion 112 and an opposite coupling portion 114. The adjacent light incidence portions 112 and coupling portions 114 are coupled with each other to form a piece-coupled light guide plate 110′. A containing space CS is formed at the junction between the light incidence portions 112 and the coupling portions 114. The light emitting devices 120 are disposed within the containing space CS and located at one side of the light incidence portions 112. In addition, the coupling of the light guide plates 110a and the through holes TH formed through coupling can be clearly understood by referring to FIG. 25.

FIG. 26 is a perspective view of a backlight module according to the second embodiment of the invention. FIG. 27 is a cross-sectional view of a backlight module according to the second embodiment of the invention. Referring to FIG. 26 and FIG. 27, the light incidence portion 112 of the light guide plate 110a is coupled with the coupling portion 114 of another light guide plate 110a. In particular, the protrusion P and the light incidence portion 112 are both locked into the locking groove 134A of the bending element 134 (as shown in FIG. 20). Thereby, a first fastening operation is performed on the light guide plate 110′ by using the bending element 134.

It can be observed in FIG. 20 that the broken holes 132A are formed at both sides of the bending element 134 and present a “U” shape. As shown in FIGS. 25˜27, starting from the top of the backlight module 102, part of the body 142 of the supporting and fastening device 140 sequentially passes through the through holes TH of the light guide plate 110′, a through hole (not shown) of the reflector 150, a through hole (not shown) of the circuit board 160, a through hole (not shown) of the insulation layer 170, and the broken hole (not shown) to the right of the bending element 134. After that, the light guide plate 110′ and films (the reflector 150, the circuit board 160, and the insulation layer 170, etc) under the light guide plate 110′ are fastened onto the back frame 130 by using the fastening portion 144, and the light guide plate 110′, the bending element 134, and films (the reflector 150, the circuit board 160, and the insulation layer 170, etc) below the bending element 134 are pressed by using the pressing portions 146 at both sides of the body 142. Namely, a second fastening operation is performed by using the supporting and fastening device 140.

Additionally, because the body 142 has an appropriate height, an air gap AP is formed between the light guide plates 110 and the optical plate assembly 180. Thereby, an appropriate light mixing distance is provided to the light emitted by the light guide plates 110 and accordingly a uniform planar light source can be achieved.

The structure of a backlight module provided by the invention is not limited to the structures of the backlight module 100 and the backlight module 102 described above. The backlight module 100 is composed of a single light guide plate 110 and a back frame 130 without the bending element 134, while the backlight module 102 is composed of a piece-coupled light guide plate 110′ and a back frame 130 having the bending element 134. However, the backlight module may also be composed of a single light guide plate 110 and a back frame 130 having the bending element 134 or a piece-coupled light guide plate 110′ and a back frame 130 without the bending element 134. These combinations are all within the scope of the invention.

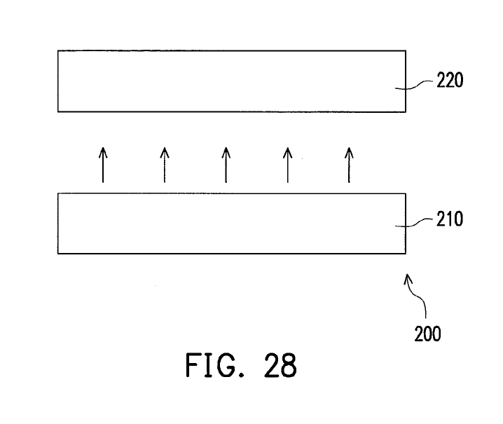

FIG. 28 is a diagram of a LCD device according to the second embodiment of the invention. Referring to FIG. 28, the LCD device 200 includes a backlight module 210 and a LCD panel 220. The LCD panel 220 is disposed at one side of the backlight module 210. The backlight module 210 can adopt any backlight module described above. The LCD device 200 offers a good image quality.

In the second embodiment described above, the backlight module and the LCD device adopt a supporting and fastening device such that the light guide plate and films below the light guide plate can be properly fastened and an appropriate light mixing distance can be provided between the light guide plate and optical films above the light guide plate. Thereby, a uniform planar light source can be provided. In addition, the light guide plate and films below the light guide plate can be further fastened by using the bending element of the back frame along with the supporting and fastening device. A LCD device having a backlight module described above can offer a good image quality.

### Third Embodiment

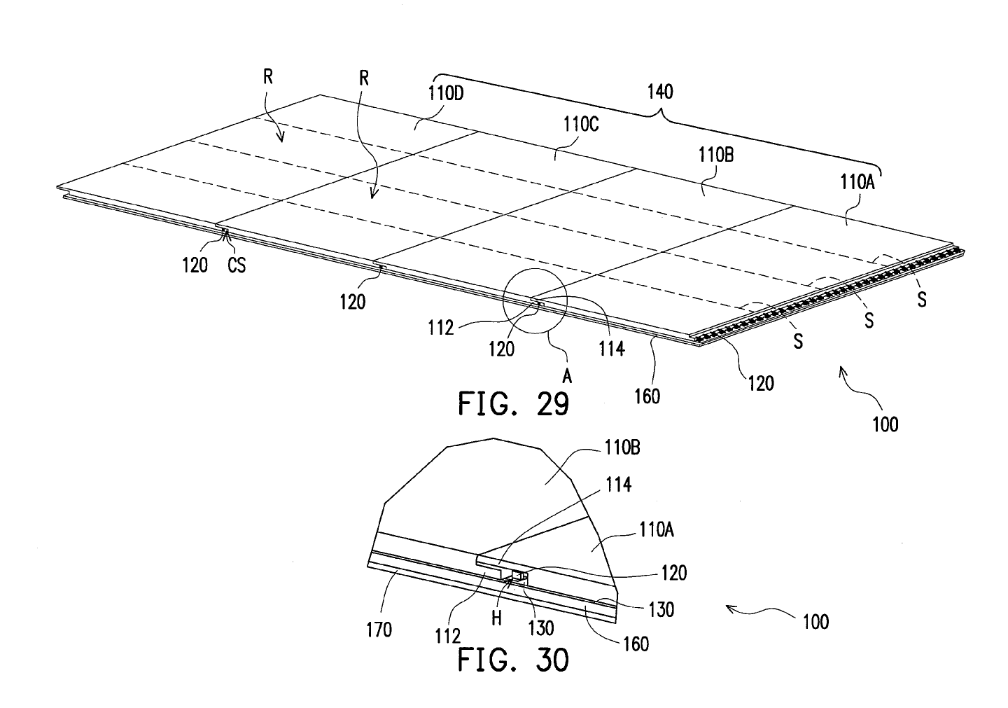

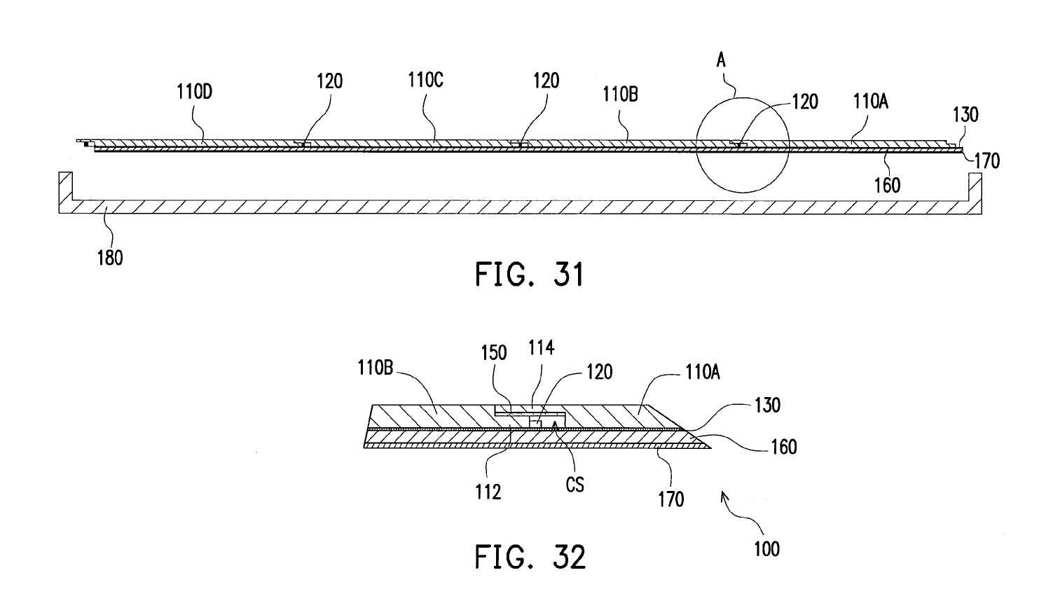

FIG. 29 is a perspective view of a backlight module according to the third embodiment of the invention. FIG. 30 is an enlarged view of area A in FIG. 29. FIG. 31 is a side view of the backlight module in FIG. 29. FIG. 32 is an enlarged view of area A in FIG. 31.

Referring to FIGS. 29-32, the backlight module 100 includes a plurality of light guide plates 110A-110D, a plurality of light emitting devices 120, and a reflector 130. Each of the light guide plates 110A-110D has a light incidence portion 112 and an opposite coupling portion 114. The adjacent light incidence portions 112 and coupling portions 114 are coupled with each other to form a piece-coupled light guide plate 140. A containing space CS is formed at the junction of the light incidence portion 112 and the coupling portion 114. The light emitting devices 120 are disposed in the containing space CS and are located at one side of the light incidence portions 112. The reflector 130 is disposed below the piece-coupled light guide plate 140.

In the embodiment illustrated in FIG. 29, a piece-coupled light guide plate 140 composed of four light guide plates 110A-110D is described as an example. However, the number of light guide plates for forming the piece-coupled light guide plate 140 is not limited herein, and in other embodiments, any other suitable number of light guide plates can be adopted according to the design requirement.

The light (not shown) emitted by the light emitting devices 120 directly enters the light guide plates 110A-110D through the light incidence portions 112 to the conducted. In particular, an entire reflector 130 is disposed below the piece-coupled light guide plate 140 which is formed by coupling light guide plates 110A-110D. Accordingly, the reflector 130 can be assembled conveniently, and the light conducted in the light guide plates 110A-110D and emitted downwards can be completely reflected upwards, so that a uniform planar light source can be achieved.

Referring to FIG. 32, the backlight module 100 further includes a light diffuser 150 disposed on a surface of the coupling portion 114 of each of the light guide plates 110A-110D that faces the light emitting devices 120. The light diffuser 150 diffuses the light emitted upwards from the light emitting devices 120, so as to make the planar light source provided by the backlight module 100 to be more uniform.

Referring to FIGS. 29-32, the backlight module 100 further includes a circuit board 160 disposed below the reflector 130. The light emitting devices 120 are electrically connected to the circuit board 160. The reflector 130 is located between the circuit board 160 and the piece-coupled light guide plate 140. A control circuit (not shown) on the circuit board 160 performs local dimming on the light emitting devices 120 to allow the light to enter all or part of the light guide plates 110A-110D. Besides, electricity required by the light emitting devices 120 for emitting light is supplied to the light emitting devices 120 through the circuit board 160. The light emitting devices 120 may be LEDs, OLEDs, or other dot light sources having similar characteristics.

As shown in FIG. 30, the reflector 130 has a hole H corresponding to the light emitting devices 120, and the light emitting devices 120 can pass through the hole H. The hole H can be in a stripe shape such that all the light emitting devices 120 can pass through the reflector 130. Or, there can be multiple holes H respectively corresponding to the light emitting devices 120 such that the light emitting devices 120 can pass through the reflector 130.

Referring to FIGS. 29-32, the backlight module 100 further includes an insulation layer 170. The insulation layer 170 is disposed below the circuit board 160. The circuit board 160 is located between the reflector 130 and the insulation layer 170. The insulation layer 170 offers an electric insulation effect between the circuit board 160 and external conductive devices (not shown) such that the circuit board 160 and the light emitting devices 120 are protected from the electric discharge effect of the external conductive devices.

In addition, as shown in FIG. 31, the backlight module 100 further includes a back frame 180, an insulation layer 170, a circuit board 160, a reflector 130, a light emitting device 120, and a piece-coupled light guide plate 140 contained in the back frame 180. Because the back frame 180 is usually made of a metal material, the insulation layer 170 can offer an electric insulation effect.

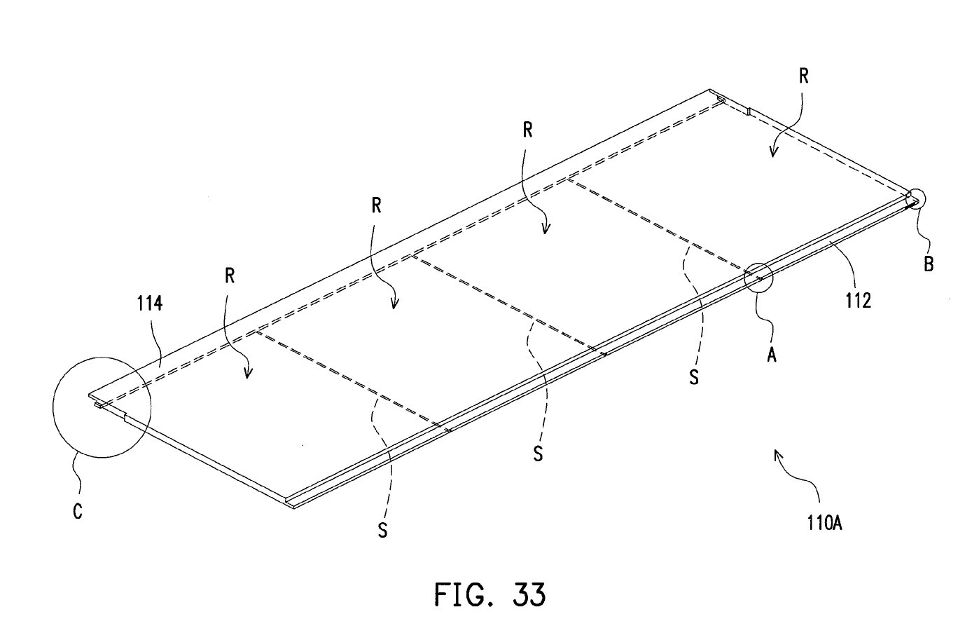

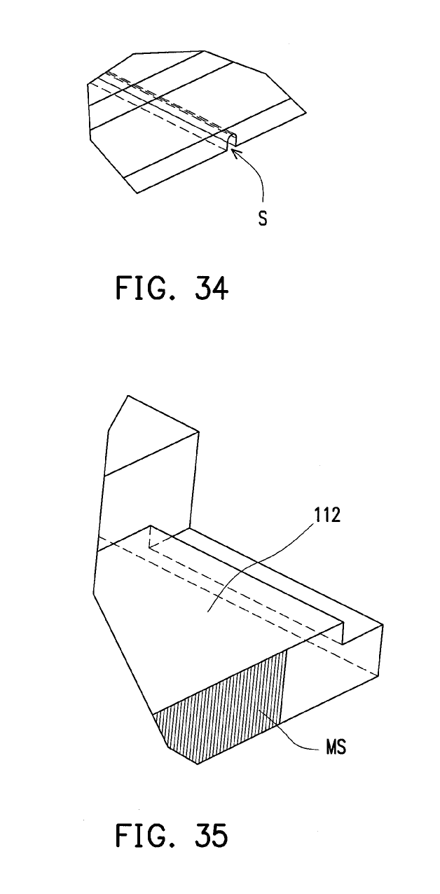

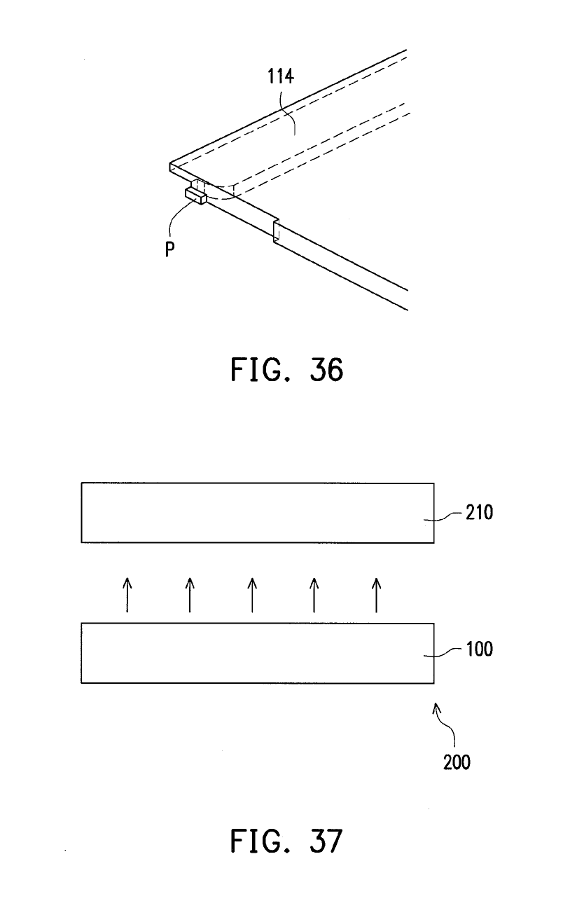

FIG. 33 is a perspective view of a light guide plate according to the third embodiment of the invention. FIG. 34 is an enlarged view of area A in FIG. 33. FIG. 35 is an enlarged view of area B in FIG. 33. FIG. 36 is an enlarged view of area C in FIG. 33.

Herein a single light guide plate 110A is described as an example, and the structure of the light guide plates 110B-110D is the same as that of the light guide plate 110A. Referring to FIG. 33-FIG. 36, the light guide plate 110A has a light incidence portion 112 and an opposite coupling portion 114. The light incidence portion 112 and the adjacent coupling portion 114 are coupled with each other to form a piece-coupled light guide plate 140. The light incidence portion 112 and the coupling portion 114 present an interactional cascading style.

Referring to FIG. 32, the light incidence portion 112 is thicker than the coupling portion 114 so that a containing space CS for containing the light emitting device 120 is formed through cascading drop. After the incidence portion 112 and the coupling portion 114 are coupled with each other, the upper surface of the light plate 110B with the light incidence portion 112 and the upper surface of the light plate 110A with the coupling portion 114 are substantially on the same plane, and the lower surfaces thereof are also substantially on the same plane. Accordingly, the reflector 130 below the piece-coupled light guide plate 140 (as shown in FIG. 29) can be attached to the piece-coupled light guide plate 140 more evenly.

As shown in FIG. 31 and FIG. 34, the light guide plate 110A has a plurality of trenches S. The trenches S divide the light guide plate 110A into a plurality of light emitting areas R. The trenches S isolate light in different light emitting areas R so that the light emitting areas R can emit light all at once or at different time. The trenches S can be formed when the light guide plate 110A is injection molded or by using a trenching tool (not shown).

As shown in FIG. 33 and FIG. 35, a microstructure MS is disposed at one side of the light incidence portion 112 of the light guide plate 110A. The microstructure MS may be a plurality of micro-grooves. The microstructure MS is disposed to facilitate the entrance of the light emitted by the light emitting devices 120 disposed at the sides of the light incidence portion 112 into the light guide plate 110A, so as to improve the light use efficiency.

As shown in FIG. 33 and FIG. 36, there is at least a protrusion P at one side of the coupling portion 114 of the light guide plate 110A. The protrusion P is coupled with a connection element (not shown) of the back frame 180 so as to stably fasten the light guide plate 110A within the back frame 180.

FIG. 37 is a diagram of a LCD device according to the third embodiment of the invention. Referring to FIG. 37, the LCD device 200 includes the backlight module 100 and the LCD panel 210. The LCD panel 210 is disposed at one side of the backlight module 100. Because the LCD device 200 has the backlight module 100, it offers a good image quality. In particular, the backlight module 100 is most suitable for large-sized LCD TVs because it adopts a piece-coupled light guide plate 140.

In the third embodiment, the backlight module and the LCD device adopt a piece-coupled light guide plate composed of a plurality of light guide plates, and a reflector is disposed below the piece-coupled light guide plate. Accordingly, light can be evenly reflected, bright lines can be eliminated, and the light use efficiency can be improved. In addition, a light diffuser is disposed on a surface of the coupling portion of the light guide plate that faces the light emitting devices such that the light emitted upwards by the light emitting devices can be diffused and accordingly the over-bright problem caused by the light emitting devices at junctions of the piece-coupled light guide plate can be resolved. Thereby, the backlight module is easy to assemble and offers a uniform planar light source.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A backlight module, comprising:
a plurality of light guide plates, wherein adjacent ones of the light guide plates are coupled with each other to form a piece-coupled light guide plate;
a plurality of light emitting devices, providing a light to the piece-coupled light guide plate; and
a back frame, having a back sheet and a bending element, wherein the back sheet has at least one broken hole, the bending element is disposed near the broken hole and forms an angle with the back sheet, the bending element has a locking groove, and the piece-coupled light guide plate is leaned against the locking groove.

2. The backlight module according to claim 1, wherein each of the light guide plates has a light incidence portion and a coupling portion opposite to the light incidence portion, the light incidence portion and the adjacent coupling portion are coupled with each other to form the piece-coupled light guide plate, and a containing space is formed at a junction of the light incidence portion and the coupling portion.

3. The backlight module according to claim 2, wherein the light emitting devices are disposed in the containing space and located at a side of the light incidence portion.

4. The backlight module according to claim 2, wherein there is at least a protrusion at a side of the coupling portion of each of the light guide plates, and the protrusion is leaned against the locking groove.

5. The backlight module according to claim 3 further comprising a light diffuser, and the light diffuser is disposed on a surface of the coupling portion of each of the light guide plates that faces the light emitting devices.

6. The backlight module according to claim 1, wherein coupling sides of the adjacent light guide plates contact each other to form the piece-coupled light guide plate, and the light emitting devices are disposed at least one side of the piece-coupled light guide plate.

7. The backlight module according to claim 1 further comprising a cushion element, wherein the cushion element is disposed on the bending element.

8. The backlight module according to claim 1 further comprising a reflector, wherein the reflector is disposed below the piece-coupled light guide plate.

9. The backlight module according to claim 8, wherein the reflector has a hole corresponding to the light emitting devices, and the light emitting devices can pass through the hole.

10. The backlight module according to claim 8 further comprising a circuit board disposed below the reflector, the light emitting devices are electrically connected to the circuit board, and the reflector is located between the circuit board and the piece-coupled light guide plate.

11. The backlight module according to claim 1, wherein each of the light guide plates has a plurality of trenches, and the trenches divide the light guide plate into a plurality of light emitting areas.

12. The backlight module according to claim 1, wherein a microstructure is disposed at a side of the light incidence portion of each of the light guide plates.

13. The backlight module according to claim 1 further comprising:
a supporting and fastening device, having a body, a fastening portion, and at least one pressing portion, wherein the fastening portion is connected to one end of the body, and the pressing portion is connected to one side of the body,
wherein the piece-coupled light guide plate has at least one through hole, a position of the through hole is corresponding to a position of the broken hole, and the piece-coupled light guide plate and the light emitting devices are disposed within the back frame;
the fastening portion and a part of the body pass through the through hole of the piece-coupled light guide plate and the broken hole of the back frame, the fastening portion is fastened to the back frame, and the pressing portion presses the light guide plates.

14. The backlight module according to claim 13, wherein there are two pressing portions, and the two pressing portions are connected to both sides of the body.

15. The backlight module according to claim 14, wherein the two pressing portions press against the piece-coupled light guide plate.

16. The backlight module according to claim 13, wherein a recess is formed at least one corner of each of the light guide plates, and the recesses of the light guide plates form the through hole.

17. The backlight module according to claim 13 further comprising an optical plate assembly, and the optical plate assembly is leaned against the body.
